(19) United States
(12) Patent Application Publication
(10) Pub. No.: US 2025/0271907 A1
(43) Pub. Date: Aug. 28, 2025

(54) ELECTRONIC DEVICE

(71) Applicant: Lenovo (Beijing) Limited, Beijing (CN)

(72) Inventors: Xiaoju GAO, Beijing (CN); Aiguo ZHENG, Beijing (CN)

(21) Appl. No.: 19/060,744

(22) Filed: Feb. 23, 2025

(30) Foreign Application Priority Data
Feb. 23, 2024 (CN) 202410205426.4

(51) Int. Cl. G06F 1/16

(52) U.S. Cl. CPC G06F 1/1675; G06F 1/1656

(57) ABSTRACT

An electronic device includes a first body, the first body including a first part and a second part, the first part including a first light-transmitting surface and a second light-transmitting surface opposite to each other; a connecting device connected to the first body; and a second body connected to the connecting device, the second body and the first body being configured to move relative to each other based on the connecting device, in a first state, the electronic device being configured to output an image through the first light-transmitting surface and at least part of an environment facing the second light-transmitting surface being visible through the first light-transmitting surface, the second part being a non-light-transmitting part.

### CROSS-REFERENCES TO RELATED APPLICATION

This application claims priority to Chinese Patent Application No. 202410205426.4 filed on Feb. 23, 2024, the entire content of which is incorporated herein by reference.

### FIELD OF TECHNOLOGY

The present disclosure relates to the field of computer technology and, more specifically, to an electronic device.

### BACKGROUND

With the development of network technology, more and more users choose to obtain and process information through electronic devices. Since the application scenarios and application environments of electronic devices will change with the needs of users, general electronic devices can no longer meet the application needs of users in multiple scenarios.

### SUMMARY

One aspect of this disclosure provides an electronic device. The electronic device includes a first body, a connecting device connected to the first body, and a second body connected to the connecting device. The first body includes a first part and a second part, and the first part includes a first light-transmitting surface and a second light-transmitting surface opposite to each other. The second body and the first body are configured to move relative to each other based on the connecting device. In a first state, the electronic device outputs an image through the first light-transmitting surface and at least part of an environment facing the second light-transmitting surface is visible through the first light-transmitting surface. The second part is a non-light-transmitting part.

Another aspect of the present disclosure provides an electronic device control method. The method includes obtaining a display instruction for an electronic device, and determining a state of the electronic device based on the display instruction. The state of the electronic device at least includes a first state. In the first state, the electronic device outputs an image through a first light-transmitting surface and at least part of the environment facing a second light-transmitting surface may be visible through the first light-transmitting surface. The electronic device includes a first body. The first body includes a first part and a second part, the first part includes a first light-transmitting surface and the second light-transmitting surface opposite to each other, and the second part includes a non-light-transmitting surface.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a schematic structural diagram of an electronic device according to some embodiments of the present disclosure.

FIG. 2 is a schematic diagram of a display effect according to some embodiments of the present disclosure.

FIG. 3 is a top view of a second body according to some embodiments of the present disclosure.

FIG. 4 is a schematic diagram of a scenario of the electronic device according to some embodiments of the present disclosure.

FIG. 5 is a side view of the second body according to some embodiments of the present disclosure.

FIG. 6 is another side view of the second body according to some embodiments of the present disclosure.

FIG. 7 is a rendering of a transparent structure of a third part of the second body according to some embodiments of the present disclosure.

FIG. 8 is a schematic diagram of an application scenario of a three-dimensional design according to some embodiments of the present disclosure.

FIG. 9 is a schematic structural diagram of the second body functional layer according to some embodiments of the present disclosure.

FIG. 10 is a flowchart of an electronic device control method according to some embodiments of the present disclosure.

### DETAILED DESCRIPTION

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

It should be noted that, when an element (which may also be a device, component, unit, module, etc.) is described as being “fixed on” or “disposed on” another element, the element may be directly located on the other element, or indirectly located on the other element. When an element is described as being “connected to” another element, the element may be directly connected to the other element, or indirectly connected to the other element. Where there is no conflict between the exemplary embodiments, the features of the following embodiments and examples may be combined with each other.

In the description of the present disclosure, it should be understood that the orientation or positional relationship indicated by the terms such as “length”, “width”, “up”, “down”, “front”, “rear”, “left”, “right”, “vertical”, “horizontal”, “top”, “bottom”, “inside”, “outside”, etc., is based on the orientation or positional relationship shown in the drawings. It is only for the convenience of describing the present disclosure and simplifying the description, and does not indicate or imply that the device or element referred to must have a specific orientation, be constructed and operated in a specific orientation, and thus cannot be understood as a limitation on the present disclosure.

In addition, terms such as “first” and “second” are used herein for purposes of description and are not intended to indicate or imply relative importance or significance. Thus, features limited by “first” and “second” are intended to indicate or imply including one or more than one these features. In the description of the present disclosure, “a plurality of” relates to two or more than two.

Embodiments of the present disclosure provide an electronic device. The electronic device can meet the requirements of user's application scenarios of the electronic device based on the relevant components of the electronic device provided by the present disclosure, such as meeting the user's need to observe objects without being blocked by the electronic device components, to not being affected by the reflection of the electronic device screen in different light scenes, and also meet the user's personalized needs for the electronic device.

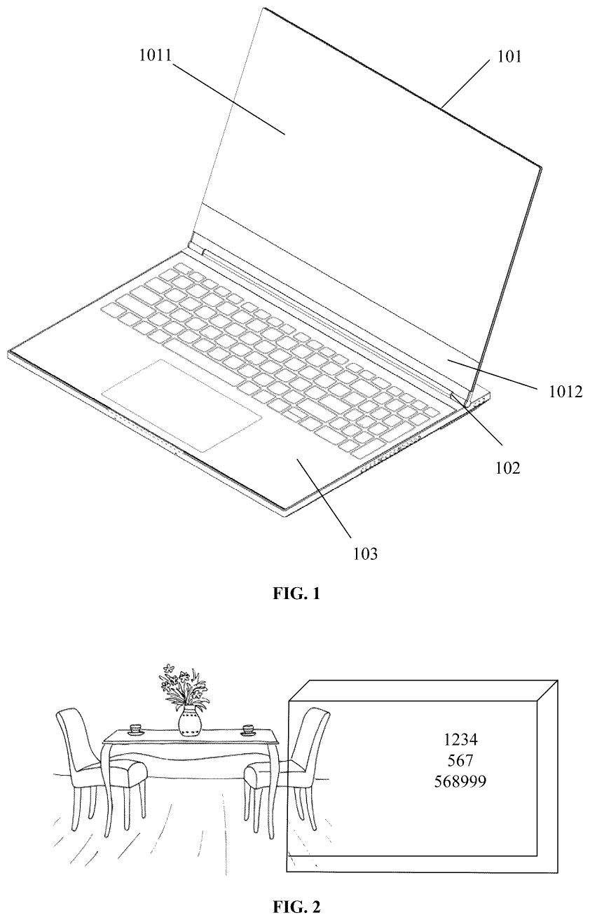

FIG. 1 is a schematic structural diagram of an electronic device 10 according to some embodiments of the present disclosure. Refer to FIG. 1, the electronic device 10 includes a first body 101, a connecting device 102, and a second body 103.

The first body 101 includes a first part 1011 and a second part 1012. The first part may include a first light-transmitting surface and a second light-transmitting surface opposite to each other. In a first state, the electronic device 10 may output images through the first light-transmitting surface and at least part of the environment facing the second light-transmitting surface may be visible through the first light-transmitting surface, and the second part may be a non-light-transmitting part.

The connecting device 102 is connected to the first body 101, and the second body 103 is connected to the connecting device 102. The second body 103 and the first body 101 can move relative to each other based on the connecting device.

As shown in FIG. 1, the first body 101 is divided into two parts. The second part 1012 is shown as a rectangle in contact with the connecting device in FIG. 1. This part may be a non-light-transmitting part. For example, a non-light-transmitting material can be used, such as a non-light-transmitting metal material or a plastic material. It should be noted that in FIG. 1, the second part 1012 is only an example of a non-light-transmitting part, which can be any non-light-transmitting coating (not limited to black). The shape of the area corresponding to the second part can also be determined based on the actual shape of the electronic device and is not limited to the rectangular shown in FIG. 1.

The present disclosure does not limit the arrangement of the first part and the second part of the first body. For example, the first part and the second part may be two parts of the same component, or may be two independent parts connected by a specific connection method.

For example, in some embodiments, when the first part and the second part are two parts of the same component, since the first part has a first light-transmitting surface and a second light-transmitting surface opposite to each other, the second part also has two opposite surfaces, such as the first non-light-transmitting surface and the second non-light-transmitting surface. The first light-transmitting surface and the first non-light-transmitting surface may face the same direction, and the second light-transmitting surface and the second non-light-transmitting surface may face the same direction. In addition, the first light-transmitting surface and the first non-light-transmitting surface may belong to the same complete transparent glass plate, except that an opaque coating may be added to the area of the first non-light-transmitting surface corresponding to the transparent glass plate. Similarly, the second light-transmitting surface and the second non-light-transmitting surface may also belong to a complete transparent glass plate, and an opaque coating may be added to the area of the second non-light-transmitting surface corresponding to the transparent glass plate. Alternatively, a non-light-transmitting structural member may be disposed in the space formed by the transparent glass plates corresponding to the first non-light-transmitting surface and the second non-light-transmitting surface such that the second part has a non-transparent visual effect for the user.

In some embodiments, the first part and the second part of the first body may be two independent parts connected by a specific connection method. For example, the first part may be an independent part with a transparent glass plate as the main material, and the second part may be an independent part with an opaque plastic material as the main material. The first part and the second part may be connected in a specific manner to form a stable and complete component, that is, a first body. For example, the first part and the second part may be connected to form the first body by means of glue bonding, and the first part and the second part may also be connected to form the first body by means of a tongue-and-groove snap connection.

Correspondingly, the present disclosure does not limit the relative position relationship between the first part and the second part. For example, the second part may be arranged above the first part, in which case the first part is relatively closer to the connecting device and the second part is relatively farther away from the connecting device; or, the second part may also be arranged below the first part, in which case the second part is relatively closer to the connecting device and the first part is relatively farther away from the connecting device; or, the second part may be arranged on both sides of the first part.

Consistent with the present disclosure, the electronic device includes a first body and a second body connected to the first body via a connecting device, and the second body and the first body can move relative to each other based on the connecting device. The first body also includes a light-transmitting first part and a non-light-transmitting second part. The first part has a first light-transmitting surface and a second light-transmitting surface opposite to each other. When the electronic device is in the first state, an image can be output through the first light-transmitting surface and at least part of the environment of the second light-transmitting surface can be visible through the first light-transmitting surface. In this state, the first body of the electronic device can present a transparent display effect, that is, part of the environment can be visible to in the first body such that the user can observe objects in the environment with being blocked by the first body. In addition, the first state of the electronic device is only one of the states of the electronic device. When the electronic device is in other states, the transmittance of the first light-transmitting surface and the second light-transmitting surface can be adjusted such that the display effect of the first body will not be affected by the ambient light, thereby providing users with more usage scenarios.

In some embodiments, to make the presentation effect of the light-transmitting surface of the first part of the first body better and the layout of the electronic device more beautiful, the second part of the first body may be arranged near the connecting device, which is convenient for presenting the display screen and the configuration of the display processing component. More specifically, a first relative distance between the second part of the first body and the connecting device may be shorter than a second relative distance between the first part of the first body and the connecting device. As shown in FIG. 1, the second part of the first body is closer to the connecting device.

The first part 1011 of the first body 101 may be a light-transmitting part, which includes a first light-transmitting surface and a second light-transmitting surface, and the first light-transmitting surface and the second light-transmitting surface may be opposite to each other. For example, the first light-transmitting surface can be understood as the light-transmitting surface of the electronic device facing the user when in user, and the second light-transmitting surface can be understood as the back area of the first light-transmitting surface, that is, the second light-transmitting surface is the light-transmitting surface of the electronic device facing away from the user when in use. The output image that the electronic device needs to output can be displayed on the first light-transmitting surface, and at the same time, at least part of the environment facing the 12 can be visible through the first light-transmitting surface. In this case, the user can perceive that the first body is transparent, and the user can observe objects behind the first body, such as people, objects, and environment, and other information of the actual scene through the first body.

FIG. 2 is a schematic diagram showing an image presented by the first light-transmitting surface of the electronic device in the first state. In FIG. 2, only the first body of the electronic device is shown to show the display effect, and the second body of the electronic device is not shown. The electronic device is in the first state, that is, a state in which the first part of the first body is transparently displayed. The environment corresponding to the second light-transmitting surface includes table and chairs. When the first light-transmitting surface outputs an image, the chair in the table and chairs in the environment facing the second light-transmitting surface is visible through the first light-transmitting surface, presenting a visual effect that the first part of the first body is transparent to the user. In this way, the user can see at least part of the objects in the environment based on the first part of the first body.

Correspondingly, the output image can also be displayed on the first light-transmitting surface, such as the numbers in FIG. 2. In this way, the user can obtain output information while also viewing objects in the environment without being blocked by the electronic device itself. For example, in a scenario where a user completes a design rendering of an object based on an electronic device, the user can obtain the visual state of the corresponding object in the environment based on the first light-transmitting surface, thereby completing the design efficiently.

When the electronic device outputs an image in the first state, it is realized based on the first light-transmitting surface and the second light-transmitting surface of the first body. Due to the existence of the first light-transmitting surface and the second light-transmitting surface, the display screen can be made transparent such that the user can see the output image and the physical objects in the environment behind the display screen at the same time. In the first state, since at least part of the environment facing the second light-transmitting surface can be visible through the first light-transmitting surface, to further improve the effect of the image output by the first light-transmitting surface, the to-be-output display information by the first light-transmitting surface can be better displayed by avoiding the entities in the environment presented by the first light-transmitting surface. As shown in FIG. 2, when the first light-transmitting surface is displaying information, there is an entity in the environment on the left side of the first light-transmitting surface. In order to avoid blocking the to-be-output display information, the to-be-output display information, such as the numbers in FIG. 2, can be displayed on the right side of the first light-transmitting surface, thereby avoiding the overlap of the actually output display information and entity in the environment in the presented display content from affecting the display effect.

Correspondingly, in some embodiments, if the information needs to be protected from privacy or the transparent effect is not needed, the state of the electronic device may also be switched, such as putting the electronic device in a second state. That is, in the embodiments of the present disclosure, the second state may be a state corresponding to the non-transparent display effect. The non-transparent display effect here may indicate that the transmittance of the first light-transmitting surface and the second light-transmitting surface is less than a preset threshold. For example, the first light-transmitting surface and the second light-transmitting surface may be completely opaque, that is, appear black; or the transmittance of the first light-transmitting surface and the second light-transmitting surface may be extremely low, that is, the light transmittance does not produce a transparent visual effect. More specifically, the corresponding control instruction can be executed based on the structure of the first light-transmitting surface and the second light-transmitting surface, thereby controlling at least part of the environment facing the second light-transmitting surface to be invisible.

For example, a dimming film may be disposed in the first part of the first body, and the transmittance of the first light-transmitting surface and the second light-transmitting surface may be controlled by the dimming film. When the transmittance of the dimming film is lower than a first threshold, the second light-transmitting surface may block the light from at least part of the objects in the environment facing the second light-transmitting surface. In this way, the electronic device is in the second state, which is similar to the display effect of a non-transparent display screen of a common laptop computer. When the transmittance of the dimming film is higher than a second threshold, the second light-transmitting surface and the first light-transmitting surface may transmit light from at least part of the objects in the environment toward which the second light-transmitting surface is facing. In this way, the electronic device is in the first state, that is, at least part of the environment facing the second light-transmitting surface can be visible through the first light-transmitting surface, presenting a transparent visual display effect.

In another example, the first part of the first body is a liquid crystal display screen, which is based on liquid crystal material, and the first light-transmitting surface and the second light-transmitting surface are planes corresponding to two parallel glass plates. Liquid crystal material is filled between the two glass plates, and voltage is used to change the arrangement of molecules inside the liquid crystal material to achieve the purpose of light shielding and light transmission. More specifically, the purpose of light shielding and light transmission is achieved by tilting the liquid crystal. For example, the liquid crystal tilting angle can be controlled to make the liquid crystal display screen transparent, such that the light from objects in the external environment can pass through the liquid crystal display into the human eye and achieve a visible state. Correspondingly, the liquid crystal tilting angle can also be controlled to shield the liquid crystal display screen from light, such that the objects in the environment facing the second light-transmitting surface cannot be visible through the first light-transmitting surface.

In some embodiments, a micro electronic gating or micro shutter processing mode may also be used to control the light transmission and light shielding of the first light-transmitting surface and the second light-transmitting surface by adjusting the voltage of the corresponding liquid crystal gating to realize the switching of the first part of the first body between the transparent display state and the non-transparent display state. That is, the switching between the first state and the second state of the electronic device can be realized, which meets the user's switching needs for display effects in various application scenarios.

The present disclosure does not limit the materials used for the first light-transmitting surface and the second light-transmitting surface, which may be any combination of one or more of a transparent glass plate, an acrylic plate, and a transparent resin.

The connecting device may be a sliding connecting device or a rotating connecting device, etc., which is not limited in the present disclosure.

The connecting device connects the first body and the second body. The first body may refer to a body with a display function, and the second body may be a body with a common input function as shown in FIG. 1, such as a body with an input method such as keyboards, a handwriting tablet or a touch pad. The second body may also be a structure that supports the first body. For example, the first body can be understood as a tablet computer, and the second body can be the based of the tablet computer. Based on this, the position or shape of the second body may be adjusted such that the tablet computer can provide more usage forms to meet different usage scenarios of users. The present disclosure does not limit the specific form of the second body.

In some embodiments, the second body may also include a third light-transmitting surface. When the first body and the second body move to the opposite state, the third light-transmitting surface may be opposite to the first light-transmitting surface. Refer to FIG. 1, when the first body and the second body are opposite to each other, when the second body has a third light-transmitting surface, the third light-transmitting surface is a plane of the second body facing upward. Take a laptop computer with four surfaces of A, B, C and D as an example. When the laptop computer is placed flat on the table and closed, the side facing upward is surface A; when the laptop computer is opened, the display surface is surface B, the side that can present input components such as the keyboard, that is, the side facing the user and opposite to surface B is surface C, and the bottom side that contacts the table is surface D. When the second body has the third light-transmitting surface, surface C of the laptop computer can present a transparent mode, which means that surface C can present the third light-transmitting surface with a transparent plate material, which can make the components at the bottom of surface C visible. That is, the user can see the visible part of the second body through the third light-transmitting surface of the second body. For example, surface C is a transparent glass plate, and the bottom layer of the transparent glass plate is the mainboard layer of the laptop computer. That is, the user can see the related components of the mainboard layer through surface C. For the convenience of description, this mode can be referred to as the transparent surface C mode.

For the electronic device to have a better display effect, in some embodiments, the electronic device may further include an image acquisition unit. The acquisition direction of the image acquisition unit and the direction of the second light-transmitting surface may meet the same condition. Take the first light-transmitting surface is facing the user as an example, the second light-transmitting surface is the light-transmitting surface facing away from the user, that is, the direction of the second light-transmitting surface is the direction the user is facing. Refer to FIG. 2, the image acquisition unit has an acquisition direction toward the environment, that is, the image acquisition unit can acquire information such as table and chairs in the environment shown in FIG. 2.

Take an image acquisition device configured toward a user in a general application scenario as an example. The image acquisition device acquires images including the user and is generally referred to as a “front acquisition device” (e.g., a front camera). Correspondingly, the image acquisition unit in the embodiments of the present disclosure acquires the environment image in the direction in which the user is facing, which can be referred to as a “rear acquisition device” (e.g., a rear camera).

In some embodiments, another image acquisition unit may be configured. The direction of the image acquisition unit and the direction of the first light-transmitting surface may meet the same condition. That is, the image acquisition unit can acquire images including the user, and can be referred to as a “front acquisition device”.

The present disclosure does not limit the location of the image acquisition unit in the electronic device, as long as the acquisition direction of the image acquisition unit and the direction of the second light-transmitting surface meet the same condition. The image acquisition unit can be arranged on the first body, the image acquisition unit can also be arranged on the second body, or the image acquisition unit can also be arranged on the connecting device. For example, the image acquisition unit can be arranged in the second part of the first body in an area that is aligned with the second light-transmitting surface, or the image acquisition unit can be arranged in the second body in an area that will not be blocked by the first body regardless of the relative motion state with the first body and is in the same direction as the second light-transmitting surface. By arranging the image acquisition unit such that its acquisition direction meets the same condition as the direction of the second light-transmitting surface, the image acquisition requirements of the electronic device in various environments can be met, which further meets the display requirements of application scenarios in which at least part of the environment facing the second light-transmitting surface can be visible through the first light-transmitting surface.

The following description uses the example of a rotational connection as an example of the connecting device of the electronic device to illustrate the structure and configuration of various parts of the electronic device of the present disclosure.

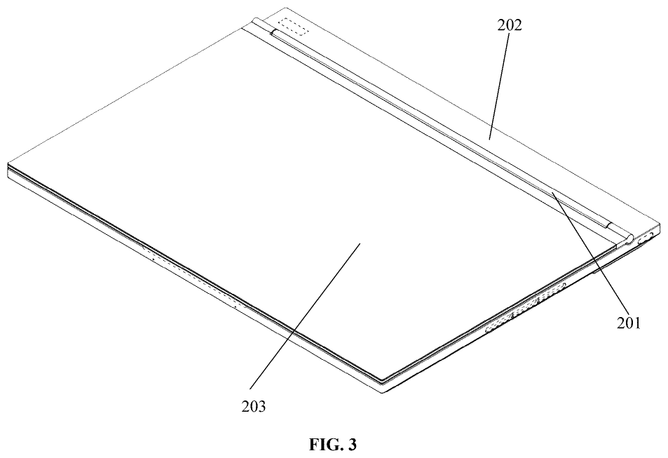

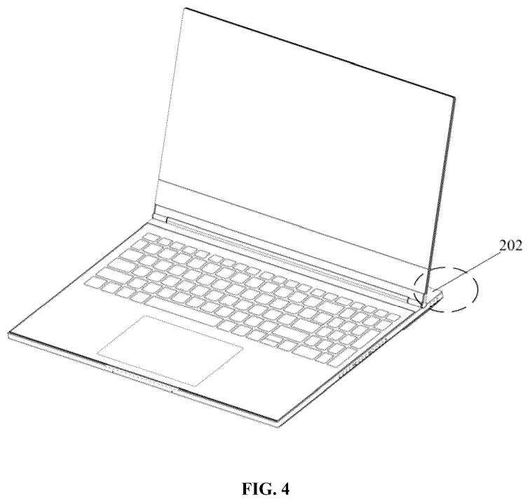

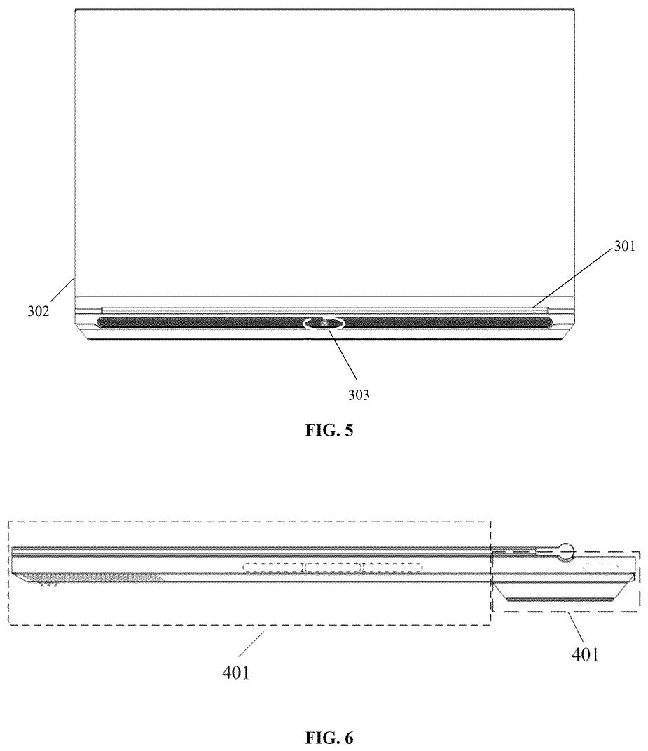

In some embodiments, the connecting device may include a rotating shaft, and the first body and the second body may rotate relative to each other based on the rotating shaft. The second body may include an extension at the connection with the rotating shaft, and the extension may not be opposite to the first light-transmitting surface of the first body. FIG. 3 is a top view of a second body according to some embodiments of the present disclosure. In FIG. 3, the cylindrical part is a rotating part 201, through which the second body rotates relative to the first body. The second body has an extension 202 at the connection with the rotating part. Also refer to FIG. 4, which is a schematic diagram of a scenario of the electronic device according to some embodiments of the present disclosure. In FIG. 4, the part within the dotted circle is the extension 202 of the second body. In FIG. 3, a plane 203 on the other side of the connection with the rotating part is a part in the second body having the third light-transmitting surface, and input components can be arranged in the plane 203. In the form of the second body of the electronic device shown in FIG. 3, the extension 202 can be formed with a relatively large receiving space to facilitate the assembly of the electronic device processing components. For example, a heat dissipation via of the electronic device may be arranged at the extension to facilitate heat dissipation of the electronic device. Refer to FIG. 5, which is a schematic diagram of the second according to some embodiments of the present disclosure. In the second body 302 in the perspective shown in FIG. 5, the rotating part 301 is connected to the second body, the second body 302 is below the rotating part shown in FIG. 5, and an image acquisition unit 303 is in the white oval dotted line frame. Further, as shown in FIG. 5, the image acquisition unit 303 is arranged in the extension of the second body, which can facilitate the acquisition of images in the environment. When the electronic device is in the first state, the relevant configuration information of the image displayed on the first light-transmitting surface can be determined through the obtained image. For example, the image displayed on the first light-transmitting surface can be avoided form the visible image area where the actual objects in the environment are displayed on the first light-transmitting surface, thereby meeting the needs of user in multiple scenarios. At the same time, arranging the image acquisition unit in the extension of the second body can also prevent the image acquisition unit from being blocked by the first body when the first body is rotated by the rotating part. Further, the distance between the circuit wiring corresponding to the image acquisition unit and the mainboard arranged in the second body can be made closer, making the wiring of the electronic device simpler.

In some embodiments, the electronic device may further include a display processing unit. The display processing unit may include a first display processing subunit and a second display processing subunit. The first display processing subunit may be disposed in an area corresponding to the second part of the second body, and the second display processing subunit may be disposed in an area corresponding to the second part of the second body. The first display processing subunit and the second display processing subunit may be configured to enable the first body to output a target image.

For example, the first body may include a first liquid crystal layer and a fluorescent layer. The liquid crystal layer is a thin film composed of liquid crystal molecules. The light transmittance is adjusted by controlling the arrangement of the liquid crystal molecules, thereby realizing the display of images. The fluorescent layer is used to convert the light from the light-transmitting liquid crystal layer into a visible image. Correspondingly, the first display processing subunit may be an image display driving unit, such as a current driving circuit capable of adjusting the arrangement of liquid crystal molecules, or a molecule for providing a driving current for electrodes in the first body, etc. The second display processing subunit may be arranged on the second body, and may be a graphics processing unit (GPU) or a central processing unit (CPU) of the electronic device. More specifically, the second display processing subunit may implement one or more processes of conversion, rendering, and enhanced display of the image signal of the to-be-displayed image.

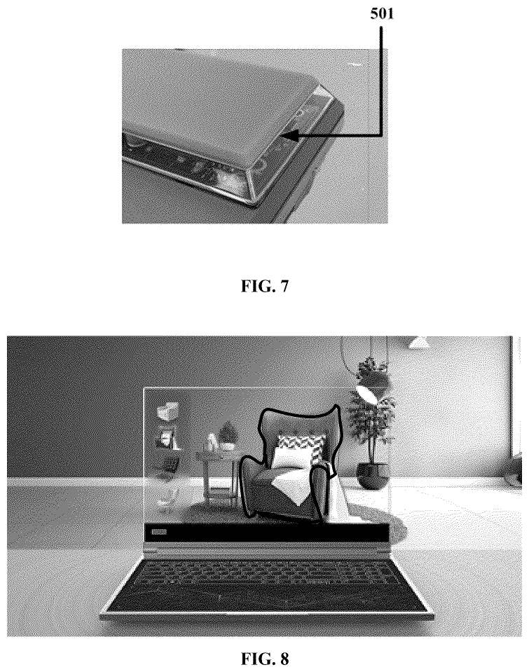

In some embodiments, the second body of the electronic device may include a third part and a fourth part, and the thickness of the third part may be greater than the thickness of the fourth part. The second display processing subunit may be arranged on the third part of the second body, and when the first body and the second body move to a relative state, the fourth part of the second body may face the first body. When the electronic device is placed on a desktop, the third part can be understood as the part closer to the desktop, and the fourth part can be understood as the part including the third light-transmitting surface. FIG. 6 is another side view of the second body according to some embodiments of the present disclosure. In FIG. 6, the part in the right dotted box 401 is the third part of the second body, and the part in the left dotted box 402 is the fourth part of the second body. The thickness of the third part is greater than the thickness of the fourth part. The third part and the fourth part of the second body may be a whole, and the thickness of the housing corresponding to the third may be greater than that of the fourth part. Or, the third part and the fourth part may be two independent parts, which are connected and fixed to form the second body. Alternatively, the third part may have two sub-parts, such as the trapezoidal and the rectangular above the trapezoidal in the dotted box 401 as shown in FIG. 6. The rectangular and the fourth part of the second body may be a whole, for example, using the same material panel. The trapezoidal of the third part as shown in FIG. 6 may be a part produced by adding a housing or other assembly methods, for example, it may be connected to the panel represented by the gray portion by a snap connection. More specifically, the third part can also be set on an assembly mode with a transparent frame, which can increase the visible area of the second body. At the same time, it can also facilitate the installation of other components. For example, a light group with colorful characteristics can be installed in the transparent area of the third part, which can provide users with a richer experience effect. FIG. 7 is a rendering of a transparent structure of the third part of the second body according to some embodiments of the present disclosure. The frame 501 of the third part in FIG. 7 can be set to a transparent material, and correspondingly, the outer housing of the third part can also be set to a transparent material. In some embodiments, the thickness of the third part may be set to be greater than the thickness of the fourth part to facilitate the arrangement of the relevant process components, for example, more receiving space can be provided for the relevant processing components. In other embodiments, the second display processing subunit may also be arranged at the raised portion at the bottom of the second body, such as the transparent visible mainboard area in FIG. 7, thereby raising the electronic device to a certain angle for easier use. Correspondingly, the second display processing subunit may also be arranged on the raised portion of the surface of the rotating shaft such that the thickness of the second body is uniform and beautiful. In another example, the second display processing subunit may also be disposed in the extension of the second body, and the component disposition area of the second body is increased through the extension to facilitate the layout of the components.

Take the structure of the first body and the second body as an example. The electronic device may include an image acquisition unit, and the acquisition direction of the image acquisition unit and the direction of the second light-transmitting surface may meet the same condition. In addition, the image acquisition unit may include a first camera and a second camera. The acquisition direction of the first camera and the direction of the second light-transmitting surface of the first body may meet the same condition. That is, the first camera can be understood as a “rear camera”. Refer to FIG. 5, the first camera can be set in the area 303 shown in FIG. 5. The acquisition direction of the second camera may meet the same condition as the direction of the first light-transmitting surface of the first body. That is, the second camera can be understood as a “front camera”. The second camera can be arranged in the second part of the first body, that is, the non-light-transmitting area of the first body facing the user, or the second camera can be arranged in the first part of the first body. For example, a layer of glass with a built-in holographic image sensor can be added to the transparent screen corresponding to the first light-transmitting surface, such that the holographic image sensor can be used as the second camera to realize the fusion interaction of the first camera and the second camera. The first camera and the second camera can be used to capture an image of the environment where the electronic device is located, and transmit the image to the display processing unit. In this way, the user can obtain an output image with better display effect based on the first light-transmitting surface and the second light-transmitting surface. For example, the image captured by the first camera and the second camera can be processed to determine a better display area on the first light-transmitting surface for the to-be-output display image such that it will not be blocked by the visible entities in the environment. In some embodiments, the first camera can be used to capture the environment image facing the second light-transmitting surface, and the second camera can be used to capture the user image facing the first light-transmitting surface. By capturing the environment image through the first camera, information such as the light in the environment can be determined, and the display parameters of the first body display can be adjusted to match the ambient light and improve the display effect. In addition, the image of the environment can also be more accurately visualized on the first light-transmitting surface. Further, if a second camera is added to capture the user's image, the use's line of sight can be tracked such that the environment image within the user's viewing angle can be used as a visual environment entity presented through the first light-transmitting surface, and the output image can be displayed in an area matching the user's viewing angle, thereby improving the user experience.

For example, when the electronic device is used in a three-dimensional (3D) object design scene, the physical object in the environment is captured by the first camera and transmitted to the display processing unit of the electronic device. In this way, the user can efficiently complete designs while seeing the real object, that is, what the user see is what he/she gets, to provide an immersive design scenario that combine virtuality and reality.

In some embodiments, the image captured by the first camera may also be directly generated into a 3D rendering of the objects in the environment through a visual processing algorithm. Users of the electronic device can compare the 3D renderings with actual objects in the environment, helping users to efficiently complete corresponding product designs. FIG. 8 is a schematic diagram of an application scenario of a 3D design according to some embodiments of the present disclosure. As shown in FIG. 8, the design of the product “sofa” is enhanced based on the rendering of the “sofa” in the environment image captured by the first camera.

In some embodiments, the electronic device may further include an input unit. The input unit may be disposed on the second body and may be visible through the third light-transmitting surface. To provide users with a better experience, the size of the input unit can match the size of the third light-transmitting surface. For example, the size of the input unit can be slightly smaller than the size of the third light-transmitting surface, or the size of the input unit can be the same as the size of the third light-transmitting surface to facilitate the user's input. Alternatively, the size of the input unit can match the input mode and the third light-transmitting surface based on different input modes of the user. For example, when the user needs to draw with a drawing board, the input unit can be a drawing board, and the size of the drawing board on the second body equals to the third light-transmitting surface, which is convenient for the user to draw images with a relatively large drawing area. The size of the input unit can also be configured based on user needs, thereby obtaining the visual effects of the input auxiliary image corresponding to the input unit in different input modes to meet different needs of users.

In some embodiments, if the input unit includes a first input layer and a second input layer, in a first input state, the input unit being in a visible state through the third light-transmitting surface includes the third light-transmitting surface presenting a first auxiliary input pattern, and the first input layer being configured to output a first input signal based on a first input operation; in a second input state, the input unit being in a visible state through the third light-transmitting surface, includes the third light-transmitting surface presenting a second auxiliary input pattern, and the second input layer being configured to output a second input signal based on a second input operation.

In some embodiments, the first input state and the second input state may be switchable. For example, the switch can be made based on the input mode currently selected by the user of the electronic device, or based on the signal generation principle of the input signal. For example, if the first input state corresponds to a pressure sensing signal, and if the electromagnetic input pen is currently providing touch input, the input state will switch to a second input state corresponding to the electromagnetic induction signal.

The signal generation principles of the first input layer and the second input layer may be the same or different. For example, the first input layer may be a touch panel input layer, and the second input layer may be a keyboard input layer, both of which generate input signals based on piezoelectric modes. By setting the first input layer and the second input layer to be input layers with the same signal generation principle, the second body can have a relatively simple manufacturing process, which is convenient for input realization of the electronic device. If the signal generation principle of the first input layer and the second input layer is different, when they are packaged in the second body at the same time, they can adapt to the space of the second body, which is convenient for controlling the cost of the electronic device.

The first input signal and the second input signal may be different, and the signal types of the keyboard and the touch panel may be different such that multiple input modes can be supported.

More specifically, the first input layer may be any sensing layer such as voltage, resistance, capacitance or ultrasonic wave, and correspondingly, the second input layer may be a sensing layer different from the first input layer.

The input unit may refer to components that can receive input operations and generate input signals. For example, keyboard and mouse, touch screen, or drawing tablet, etc. The first input state may refer to an input state through a keyboard or a touch pad. That is, an input state through pressure sensing. The corresponding first input layer may be an input layer that can respond through a pressure sensing signal. If the types of input operations corresponding to the first input layer are different, but the principles of generating the input signals are the same, the first input layer can also be divided into discontinuous areas. For example, the input method corresponding to the first input layer may include a keyboard input method and a mouse touch input method, and the first input layer may be divided into two discontinuous areas. That is, one area is used to receive the user's keyboard input operations, and the other area is used to receive the user's mouse input operations. In this way, false triggering of different input operations can be avoided, such that more accurate input signals can be generated. Alternatively, when different input operations of the user are detected, the input signal generation method of the corresponding input layer can be adjusted to ensure that the input signal can be accurately generated. For example, if the user inputs by double-clicking, it will be recognized as using the mouse input method, and the user will respond in a response manner corresponding to the mouse input method to generate a corresponding input signal.

In some embodiments, the input unit may present a first auxiliar input pattern through the third light-transmitting surface. The first auxiliar input pattern may be the target characters corresponding to the keyboard, that is, various characters in the physical keyboard, including numbers, letters, punctuation marks, and function keys, etc. The first auxiliar input pattern may also be a touch pattern corresponding to the touch panel, such as a border of the effective touch area of the tough panel, a touch mode switching button, etc. The second input layer may be an input layer that can respond to electromagnetic sensing signals, and a second auxiliary input pattern presented by the third light-transmitting surface may be a pattern that can sense electromagnetic signals, such a drawing area pattern that can receive input operations of an electromagnetic drawing pen. More specifically, the second auxiliary input pattern may include a brush button of a drawing board, a graphic selection button, etc. In this way, the user can use an electromagnetic drawing pen to perform a drawing operation based on the second auxiliary input pattern, thereby generating a drawing input signal.

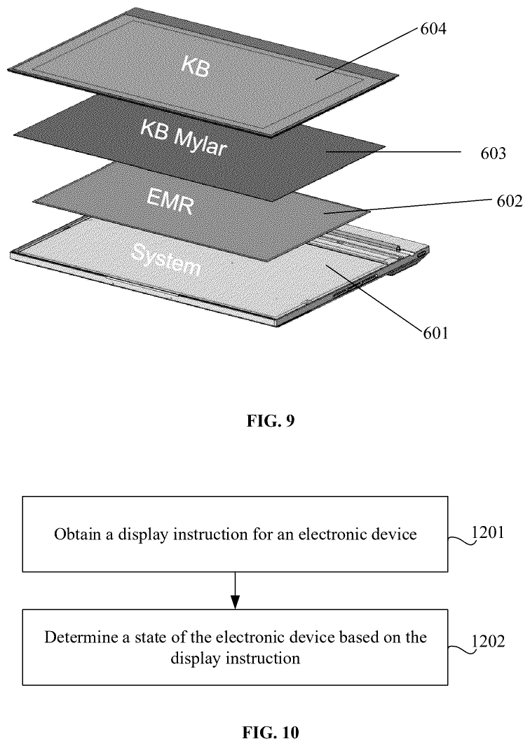

FIG. 9 is a schematic structural diagram of the second body functional layer according to some embodiments of the present disclosure. FIG. 9 shows the structure of the main functional layers of the second body. As shown in FIG. 9, a system layer 601 in an electrical carrier layer, that is, a circuit board layer rather than a surface D. The system layer 601 can also be referred to as a mainboard layer. The layer above the system layer 601 is an EMR layer 602, that is, an electromagnetic touch layer. The layer above the EMR layer is a KB mylar layer 603, that is, the keyboard polyester film layer. The layer above the KB mylar layer is a keyboard layer 604, represented by KB. Correspondingly, the third light-transmitting surface may be provided on the keyboard layer, such as a transparent glass, which is not shown in FIG. 9. It should be noted that in order to provide users with a more transparent visual experience, the housing of the second body encapsulating the functional layers described above can be made of a transparent material. For example, when the electronic device is a laptop computer, surface D thereof may be transparent. That is, a transparent material can be used to encapsulate the bottom of the electronic device, and correspondingly, the frame of the second body of the electronic device can also be transparent.

In addition, in some embodiments, the receiving space formed by the second body may include a carrier for carrying electronic components. The carrier may refer to a circuit board. That is, a circuit board may be arranged in the receiving space formed by the second body, and the circuit board may carry electronic components with various functions, such as a processing component with a processing function, a display processing component, a heat dissipation component, a light emitting component, etc. In some embodiments, the second body may include a third light-transmitting surface, and the carrier may be in a visible state through the third light-transmitting surface.

In some embodiments, since the second body is also provided with an input unit, the input unit can be visible through the third light-transmitting surface, thereby further reducing the power consumption of the electronic device while realizing the input function. In the embodiments of the present disclosure, when the electronic device is in different power consumption modes, the visible image corresponding to the third light-transmitting surface may be different. In some embodiments, the input unit may also include a light guide. The light guide may be used to assist the third light-transmitting surface in presenting a corresponding pattern. In some embodiments, when the electronic device is in a first power consumption mode, the light guide may be used to project light onto the third light-transmitting surface to form the first auxiliary pattern or the second auxiliary input pattern. When the electronic device is in a second power consumption mode, the carrier may be visible through the third light-transmitting surface. The power consumption in the first power consumption mode may be greater than the power consumption in the second power consumption mode. For example, the first power consumption mode may be a normal working mode of the electronic device, and the second power consumption may be a dormant, sleeping, shutdown or power-off mode of the electronic device. That is, in the first power consumption mode, the third light-transmitting surface can form a pattern for assisting user input. In the second power consumption mode, it can be considered that there is no need to respond to the user's input command temporarily, such that the carrier can be in a visible state through the third light-transmitting surface, that is, the corresponding auxiliary input pattern is no longer generated, thereby further reducing the power consumption of the electronic device. It should be noted that, in some embodiments, the input unit may be in a visible state through the third light-transmitting surface. That is, when the third light-transmitting surface can present the first auxiliary input pattern or the second auxiliary input pattern, the carrier can also be visible through the third light-transmitting surface. In some embodiments, the size of the presentation area of the auxiliar input pattern corresponding to the input unit may be smaller than the size of the third light-transmitting surface. The electronic components on the second body circuit board can be seen through the area of the third light-transmitting surface that does not correspond to the auxiliary input pattern, and the light transmittance of the auxiliary input pattern can also be set within a certain light transmittance range. In this way, the auxiliary input patterns can be presented and the electronic components on the circuit board are visible.

In some embodiments, to improve the application effect of the electronic device and meet the personalized needs of users, the electronic device may also include a first light-emitting module and a second light-emitting module arranged on the second body. The first light-emitting module may be connected to a first optical unit, and the first optical unit may be arranged on the second body and used to adjust the light received by the first light-emitting unit to realize the light presentation requirements of different areas on the second body. The light-emitting parameters of the first light-emitting module may match the output information of the first body.

More specifically, the first light-emitting module may include a first light-emitting unit and a driver of the first optical unit. The first light-emitting unit may be a group of RGB lights. More specifically, the RGB lights in the embodiments of the present disclosure can be three independent lights of red (R), green (G), and blue (B), or three independent lights packaged together. If there are three independent lights, the light-emitting parameters of each light need to be controlled by a light-emitting controller to obtain the light-emitting effect of the corresponding light-emitting color. If it is an independent light, the light-emitting parameters of the light can be directly controlled. The first optical unit may be a light-guiding circuit or a light-guiding module, etc. For example, the first optical unit may be an optical fiber, a nano-optical circuit, an optical coating, etc. The driver may be a current driving unit of the first optical unit, which provides a corresponding driving current for the first optical unit such that the light of the first optical unit is uniform. In some embodiments, the first optical unit may be disposed on a target area on the second body, and the target area may be an area where the keyboard presents characters. In this way, the brightness of each character is uniform and can meet the keyboard brightness requirements. By increasing the current and adjusting the thin-film photoconductive circuit, the keyboard brightness and uniformity can be improved.

The light-emitting parameters of the second light-emitting module may match the output information of the first body. In some embodiments, the light-emitting parameters may include parameters such as light-emitting brightness, light-emitting frequency and light-emitting color. When a user listens to a song or watches a movie through an electronic device, the first light-transmitting surface can display relevant information of the song, such as lyrics or video images, and the corresponding light-emitting frequency of the second light-transmitting module can match the audio frequency of the song. For example, if there is soothing part in the song, the second light-emitting module can flash at a slower frequency. When entering a more cheerful part of the song, the light-emitting module can flash at a faster frequency. In addition, the light of the second light-emitting module can be projected through the third light-transmitting surface of the second body. In this way, the second body can present a breathing light-like state based on the third light-transmitting surface, and can move along with the rhythm of the audio or video content currently output by the electronic device, thereby improving the user experience.

An embodiment of the present disclosure also provides an electronic device control method. FIG. 10 is a flowchart of an electronic device control method according to some embodiments of the present disclosure. The method will be described in detail below.

1201, obtaining a display instruction for an electronic device.

1202, determining a state of the electronic device based on the display instruction.

The state of the electronic device may at least include a first state. In the first state, the electronic device may output an image through a first light-transmitting surface and at least part of the environment facing a second light-transmitting surface may be visible through the first light-transmitting surface. The electronic device may include a first body. The first body may include a first part and a second part. The first part may include the first light-transmitting surface and the second light-transmitting surface opposite to each other, and the second part may include a non-light-transmitting surface.

The method further includes: detecting the environmental characteristics of the electronic device; determining a first brightness parameter of the first light-transmitting surface based on the environmental characteristics to cause the first light-transmitting surface to output an image based on the first brightness parameter; and/or, determining a second brightness parameter of the third light-transmitting surface based on the environmental characteristics to cause the third light-transmitting surface to determine a light transmission parameter based on the second brightness parameter. In some embodiments, the third light-transmitting surface may be arranged on the second body, and the second body may be connected to the first body through a connecting device.

In some embodiments, an image acquisition unit of the electronic device may be used to detect and obtain the environmental characteristics of the electronic device. That is, the ambient brightness information of the electronic device can be obtained to adjust the brightness information of the first light-transmitting surface of the first body. For example, the brightness of the display screen of an electronic device can be adjusted to provide users with better visual effects. In addition, an ambient brightness sensor may be built into the electronic device to detect the ambient brightness to control the screen brightness of the electronic device to change intelligently with the ambient brightness. In some embodiments, the light transmittance of the first light-transmitting surface may be adjusted based on the ambient brightness. If the environment is bright, the light transmittance can be lowered to make the displayed image more prominent and provide users with better visual effects.

In some embodiments, the user's visual information may also be collected by an image acquisition unit facing the same direction as the electronic device and the first light-transmitting surface. In this way, the image acquisition unit of the electronic device can determine the user's viewing point based on the user's visual information such that the environment corresponding to the viewing point can be made visible through the first light-transmitting surface. In addition, the characteristics of the current environment can also be collected through the image acquisition unit of the electronic device. For example, when it is detected that there are many other users in the current environment near the user of the electronic device, the first light-transmitting surface can be automatically switched to a non-light-transmitting mode, that is, a normal display screen mode, and no longer presents a transparent display state, thereby protecting the security of information.

It should be noted that the display instruction for the electronic device obtained in the embodiments of the present disclosure may be a monitoring instruction based on a shortcut key for switching the display mode. For example, the first shortcut key on the second body may represent the transparent display mode. That is, when it is detected that the user triggers the first shortcut key, the electronic device may be switched to the first state. While the first light-transmitting surface outputs an image, at least part of the environment facing the second light-transmitting surface can be visible through the first light-transmitting surface, that is, a transparent display effect of the display screen is realized. If the electronic device is in the first state and the user triggers a second shortcut key, the second shortcut key representing the normal display mode, the electronic device may be switched to the second state, that is, the non-light-transmitting mode of the first light-transmitting surface. In this way, the normal display mode of the display screen is realized. That is, only the currently output image is displayed, and objects in the environment cannot pass through the first light-transmitting surface and are in a non-visible state.

In some embodiments, the display instruction may also be determined based on detecting the user environment. If there is one user of the electronic device at present, the electronic device may be in the first state to realize the transparent display effect of the display screen. If multiple users are detected, in order to ensure data security, the electronic device may be switched to the second state to realize the display effect of a normal display screen.

In some embodiments, the display instruction may also be determined based on the application currently used by the user. For example, if the user selects video playback, the display effect may be normal; if the user selects an application for designing 3D objects, the display effect may be switched to a transparent effect to facilitate user's drawing.

In some embodiments, a default mode of the first body display may also be set first. For example, the default mode may be the first state, that is, the display effect of the transparent screen. For example, the transmittance of the first light-transmitting surface and the second light-transmitting surface may be 55%. When the user wants to switch to the opaque mode to better protect office privacy, the user can press the shortcut key on the keyboard to switch directly. The opaque mode uses a micro-electronic gating or micro-blind design, and controls the switch by adjusting the voltage, which can effectively reduce the screen contract without affecting the display under the transparent screen.

In some embodiments, the transparent effect of the second body may also be realized. That is, the second body has a third light-transmitting surface. If the electronic device is in the form of a laptop computer, a fully transparent surface C design can be realized. In addition, the frame and surface D of the second body may also be light-transmitting surfaces, that is, they may also be packaged with transparent materials. When a fully transparent surface C is used, the user can see the mainboard in the second body through the third light-transmitting surface, and can also integrate the EMR (electromagnetic touch screen) drawing board to realize seamless switching between the keyboard and the drawing board.

Considering the reduction of power consumption of the electronic device, in some embodiments, when the electronic device is turned off or in other low power consumption states, surface C and the transparent screen may be fully transparent. When the system is turned on, the monochrome keyboard and the full-size keyboard will be displayed directed on surface C, forming an auxiliary input pattern. When the keyboard and touchpad are not used for a period of time, such as within 30 seconds, the screen will automatically turn off. Clicking anywhere on surface C will directly wake up the system. In some embodiments, a variety of different keyboard colors may be arranged for the user to choose from. These colors can be projected onto the transparent surface through the conversion of RGB LED lights. When the user wants to have a better gaming, music or movie experience, the user can adjust the surface C transparent keyboard to the breathing light state, and the breathing light can move with the rhythm. When the user needs to draw, the user can touch surface C with the EMR pen to switch from the keyboard mode to the drawing board mode, and at the same time, call the user's commonly used drawing software. The switching is intelligent and the operation is simple. Based on the electronic device and the corresponding control method provided in the embodiments of the present disclosure, the user's need to work anywhere can be realized. Whether indoors or outdoors, the display effect of the electronic device can meet the user's needs, and an immersive creative environment can also be provided. The transparent display effect based on the display screen can assist users in creating 3D objects, and provide switching between multiple display modes and input modes, ensuring convenience of use in more application scenarios.

In the present specification, the embodiments are described in a gradual and progressive manner with the emphasis of each embodiment on an aspect different from other embodiments. The same or similar parts among the various embodiments may refer to each other. Since the disclosed device embodiment corresponds to the disclosed method embodiment, detailed description of the disclosed device is omitted, and reference can be made to the description of the methods for a description of the relevant parts of the device.

As will be appreciated by those of ordinary skill in the art, the embodiments disclosed herein can be implemented by way of electronic hardware, computer software, or a combination of the two. To clearly illustrate the interchangeability between hardware and software, components and steps of respective examples have already been described in a general way in terms of functions in the above description. These functions are to be executed by hardware manner or software manner depending upon the particular application of the technique process and design constraints. Those skilled in the art can use different methods to achieve the described functions with respect to each specific application, but such implementation should not be construed as going beyond the scope of the present disclosure.

The processes of the methods or algorithms described in conjunction with the embodiments of the present disclosure can be implemented with hardware, software modules executed by a processor, or a combination thereof. The software modules may reside in a random-access memory (RAM), an internal memory, a read-only memory (ROM), an electrically programmable ROM, an electrically-erasable programmable ROM, a register, a hard disk, a removable disk drive, CD-ROM, or other types of storage media well known in the technical field.

The foregoing description of the disclosed embodiments will enable a person skilled in the art to realize or use the present disclosure. Various modifications to the embodiments will be apparent to those skilled in the art. The general principles defined herein may be implemented in other embodiments without departing from the spirit or scope of the disclosure. Accordingly, the disclosure will not be limited to the embodiments shown herein, but is to meet the broadest scope consistent with the principles and novel features disclosed herein.

What is claimed is:

1. An electronic device comprising:
a first body, the first body including a first part and a second part, the first part including a first light-transmitting surface and a second light-transmitting surface opposite to each other;
a connecting device connected to the first body; and
a second body connected to the connecting device, the second body and the first body being configured to move relative to each other based on the connecting device, wherein:
in a first state, the electronic device outputs an image through the first light-transmitting surface and at least part of an environment facing the second light-transmitting surface is visible through the first light-transmitting surface, and the second part is a non-light-transmitting part.

2. The electronic device of claim 1, wherein:
the second body includes a third light-transmitting surface, the third light-transmitting surface being opposite to the first light-transmitting surface when the first body and the second body are in an opposing state.

3. The electronic device of claim 1 further comprising:
an image acquisition unit, an acquisition direction of the image acquisition unit and a direction of the second light-transmitting surface meeting the same condition.

4. The electronic device of claim 1, wherein:
the connecting device includes a rotating shaft, the first body and the second body being configured to rotate relative to each other based on the rotating shaft; and
the second body includes an extension at a connection with the rotating shaft, the extension being a part not opposite to the first light-transmitting surface of the first body.

5. The electronic device of claim 4 further comprising:
an image acquisition unit, an image acquisition unit being disposed in the extension of the second body.

6. The electronic device of claim 1, wherein:
a first relative distance between the second part of the first body and the connecting device is shorter than a second relative distance between the first part of the first body and the connecting device.

7. The electronic device of claim 6 further comprising:
a display processing unit, the display processing unit including a first display processing subunit and a second display processing subunit, the first display processing subunit being disposed in an area corresponding to the second part of the first body, the second display processing subunit being disposed on the second body, the first display processing subunit and the second display processing subunit being configured to cause the first body to output a target image.

8. The electronic device of claim 7, wherein:
the second body includes a third part and a fourth part, thickness of the third part being greater than thickness of the fourth part, the second display processing subunit being disposed on the third part of the second body, the first body being opposite to the fourth part of the second body when the first body and the second body move to an opposite state.

9. The electronic device of claim 1 further comprising:
an input unit, the input unit being disposed on the second body and visible through the third light-transmitting surface, wherein:
if the input unit includes a first input layer and a second input layer,
in a first input state, the input unit being visible through the third light-transmitting surface includes the third light-transmitting surface being configured to display a first auxiliary input pattern, and the first input layer being configured to output a first input signal based on a first input operation;
in a second input state, the input unit being visible through the third light-transmitting surface includes the third light-transmitting surface being configured to display a second auxiliary input pattern, and the second input layer being configured to output a second input signal based on a second input operation.

10. The electronic device of claim 9, wherein:
a receiving space formed by the second body includes a carrier for carrying electronic components, and the input unit also includes a light guide; the light guide being used to project light onto the third light-transmitting surface to form the first auxiliary input pattern or the second auxiliary input pattern when the electronic device is in a first power consumption mode;
the carrier being visible through the third light-transmitting surface when the electronic device is in a second power consumption mode.

11. The electronic device of claim 1 further comprising:
a first light-emitting module and a second light-emitting module disposed on the second body, the first light-emitting module being connected to a first optical unit disposed on the second body, the first optical unit being configured to adjust the light received by a first light-emitting unit to realize light presentation requirements of different areas on the second body; light-emitting parameters of the first light-emitting module being configured to match output information of the first body.

12. The electronic device of claim 1 further comprising:
in a second state, at least part of an environment facing the second light-transmitting surface is non-visible,
wherein the first state and the second state can be switched.

13. A control method, comprising:
obtaining a display instruction for an electronic device;
determining a state of the electronic device based on the display instruction;
the state of the electronic device at least include a first state, in the first state, the electronic device output an image through a first light-transmitting surface and at least part of the environment facing a second light-transmitting surface may be visible through the first light-transmitting surface;
the electronic device include a first body, the first body include a first part and a second part, the first part include a first light-transmitting surface and the second light-transmitting surface opposite to each other, and the second part include a non-light-transmitting surface.

14. The method according to claim 13, further includes:
detecting an environmental characteristics of the electronic device;
determining a first brightness parameter of the first light-transmitting surface based on the environmental characteristics to cause the first light-transmitting surface to output an image based on the first brightness parameter; and/or,
determining a second brightness parameter of a third light-transmitting surface based on the environmental characteristics to cause the third light-transmitting surface to determine a light transmission parameter based on the second brightness parameter.
the third light-transmitting surface be arranged on the second body, and the second body is connected to the first body through a connecting device.
